(19) United States
(12) Patent Application Publication
(10) Pub. No.: US 2002/0042803 A1
(43) Pub. Date: Apr. 11, 2002

(54) Arithmetic operation unit suitable for correcting lost data by general-purpose computer

(75) Inventor: Takayuki Sugawara, Fukushima-ken (JP)

Correspondence Address: Brinks Hofer Gilson & Lione, P.O. Box 10395, Chicago, IL, 60610, US

(73) Assignee: Alps Electric Co., Ltd.

(21) Appl. No.: 09/924,707

(22) Filed: Aug. 8, 2001

(30) Foreign Application Priority Data
Aug. 11, 2000 (JP) 2000-243774

(51) Int. Cl. G06F 7/00

(52) U.S. Cl. 708/492

(57) ABSTRACT

When power calculation (αⁱ) of α as the element of a primitive polynomial on a Galois field is executed to make arithmetic operation of symbols at a time data is encoded in and decoded from a recording medium, a shift operation section of i bits and a reference table of the numbers of 2ⁱ are provided to calculate αⁱ.

### BACKGROUND OF THE INVENTION

1. Field of the Invention

The present invention relates to an arithmetic operation unit capable of multiplying elements of a Galois field at a high speed, and more specifically, to an arithmetic operation unit suitable for in a general-purpose computer for correcting lost data.

2. Description of the Related Art

In error correction processing that is executed when data is recorded in, and reproduced from, a recording medium, check symbols E₀, E₁, E₂, . . . are encoded in the recording medium as additional codes. When the data is reproduced, symbols S₀, S₁, S₂, . . . are determined by ExOring data (user symbols) with the check symbols E₀, E₁, E₂, . . . Then, the magnitude of any error is calculated by subjecting the symbols to an arithmetic operation.

While these symbols E₀ and S₀ can be determined by the calculation of simple exclusive OR, power calculation of α is necessary for symbols E₁ and S₁ or higher. Here, α is defined as an element when a primitive polynomial G (X) on a Galois field is made to 0.

Since a recording-reproducing apparatus and the like is not provided with an arithmetic operating section dedicated for a Galois field, it determines the check symbol E and the symbol S in decoding by means of a look-up table.

Hitherto, a table of 8 bits (256)×8 bits (256)=64k bytes is used as the look-up table. Thus, it is possible to determine the check symbol E and the symbol S in decoding as to data each having 8 bits. However, since computers presently have an access width of a unit of 16 bits or 32 bits, it is preferable to execute the arithmetic operation of the symbols by the unit of 16 bits or 32 units.

However, the arithmetic operation of the unit of 16 bits, for example, requires a table of 16 bits (64k bytes)×16 bits (64k bytes)=4G bytes, the construction of which is a practical impossibility.

Further, while to the use a power expression conversion table has also been contemplated, this similarly requires a table on the order of several hundreds of kilobytes for a unit of 16 bits or larger.

### SUMMARY OF THE INVENTION

An object of the present invention, which has been made to solve the above conventional problem, is to provide an arithmetic operation unit capable of executing power calculation using the element α of an Galois field at a high speed and correcting, for example, lost data at a high speed.

The present invention is characterized in an arithmetic operation unit for multiplying αⁱ when the element of G(X)=0 of a primitive polynomial G(X) on a Galois field represented by the following Expression (1) is represented by α, the arithmetic operation unit comprising a shift operating section for shifting elements by i bits before multiplication and a referring section for referring to a look-up table of 2ⁱ pieces of elements when the multiplier of α is represented by i.

G₍ₓ₎=gₘx^{m}+gₘ₋₁x^{m-2}+gₘ₋₂x^{m-2}+. . . +gₚ₊₁x^{p+1}+gₚx^{p}+. . . +g₀. . . (1)

Further, the present invention relates to an arithmetic operation unit for calculating U·αⁱ based on an element U on the Galois field represented by the following Expression (2) when the element of G₍ₓ₎=0 of a primitive polynomial G₍ₓ₎ on a Galois field represented by the above Expression (1) is represented by α, wherein a shift operating section for shifting the element of the U by i bits is ExOred with a referring section for referring to a look-up table having 2ⁱ pieces of elements according to the least significant i bits of the U.

U=αⁿuₙ+αⁿ⁻¹uₙ₋₁+. . . +α²u₂+α¹u₁+u₀ . . . (2)

Further, when data (user symbols) is represented by D₁, D₂, . . . , Dₖ, error check symbols represented by the following Expression (3) are calculated.

$${D}_{1} + {D}_{2} + {D}_{3} + ⋯ + {D}_{k - 1} + {D}_{k} = {E}_{0} \\ {α}^{k} {D}_{1} + {α}^{k - 1} {D}_{2} + {α}^{k - 2} {D}_{3} + ⋯ + {α}^{2} {D}_{k - 1} + α {D}_{k} = {E}_{1} \\ {α}^{{( k )}^{2}} {D}_{1} + {α}^{{( k - 1 )}^{2}} {D}_{2} + {α}^{{( k - 2 )}^{2}} {D}_{3} + ⋯ + {α}^{4} {D}_{k - 1} + {α}^{2} {D}_{k} = {E}_{2} \\ ⋮ ⋮ \\ {α}^{{( k )}^{n - k - 1}} {D}_{1} + {α}^{{( k - 1 )}^{n - k - 1}} {D}_{2} + ⋯ + {α}^{n - k} {D}_{k - 1} + {α}^{n - k - 1} {D}_{k} = {E}_{n - k - 1} \qquad ( 3 )$$

In addition to the above, when data (user symbols) is decoded, symbols S₀, S₁, S₂, . . . , Sₙ₋ₖ₋₁ are obtained by calculating the following Expression (4).

$${D}_{1} + {D}_{2} + {D}_{3} + ⋯ + {D}_{k - 1} + {D}_{k} + {E}_{0} = {S}_{0} \\ {α}^{k} {D}_{1} + {α}^{k - 1} {D}_{2} + {α}^{k - 2} {D}_{3} + ⋯ + {α}^{2} {D}_{k - 1} + α {D}_{k} + {E}_{1} = {S}_{1} \\ {α}^{{( k )}^{2}} {D}_{1} + {α}^{{( k - 1 )}^{2}} {D}_{2} + {α}^{{( k - 2 )}^{2}} {D}_{3} + ⋯ + {α}^{4} {D}_{k - 1} + {α}^{2} {D}_{k} + {E}_{2} = {S}_{2} \\ ⋮ ⋮ \\ {α}^{{( k )}^{n - k - 1}} {D}_{1} + {α}^{{( k - 1 )}^{n - k - 1}} {D}_{2} + ⋯ + {α}^{n - k} {D}_{k - 1} + {α}^{n - k - 1} {D}_{k} + {E}_{n - k - 1} = {S}_{n - k - 1} \qquad ( 4 )$$

Further, when the magnitude of an error is determined using the symbols S₀, S₁, S₂, . . . , Sₙ₋ₖ₋₁, the magnitude of the error is determined by providing the following inverse element reference table and referring to the table.

a) α¹, α², . . . α^{k}

b) 1+α¹, 1+α², . . . 1+α^{k}

### BRIEF DESCRIPTION OF THE DRAWINGS

FIG. 1 is a block diagram showing an example of an α multiplication circuit.

### DESCRIPTION OF THE PREFERRED EMBODIMENTS

The present invention provides an arithmetic operation unit capable of multiplying αⁱ at a high speed when the element of a primitive polynomial G(X) on a Galois field, which has a dimension in coincidence with the access width (for example, 16 bits, 32 bits, and the like) of a computer, is represented by α. The arithmetic operation unit of the present invention can execute multiplication even if the computer has a large access width. Thus, the arithmetic operation unit of the present invention correct an error in a unit of larger than 8 bits, thereby overcoming the limitations of a conventional arithmetic operation unit.

Table 1 shows a format, which is represented in a unit of one block, of data recorded in a magnetic disc or the like.

TABLE 1

| Packet | Double | Double | Double | | Double Word |
|---|---|---|---|---|---|
| No | Word 0 | Word 1 | Word 2 | | 127 |
| 0 | Byte 0-3(D₁) | Byte 4-7 | Byte 8-11 | — | Byte 508-511 |
| 1 | Byte 0-3(D₂) | Byte 4-7 | Byte 8-11 | — | Byte 508-511 |
| — | — | — | — | — | — |
| 63 | Byte 0-3(D₆₃) | Byte 4-7 | Byte 8-11 | — | Byte 508-511 |
| 64 | ECC[0] | ECC[0] | ECC[0] | — | ECC[0] |
| 65 | ECC[1] | ECC[1] | ECC[1] | — | ECC[1] |

Table 1 shows Packet Nos. in a longitudinal direction, wherein Nos. 0 to 63 show user blocks including data (user symbols) Packet Nos. 64 and 65 include check symbols E₀ and E₁ for correcting errors. These check symbols E₀ and E₁ are codes for correcting errors.

The data from Packet Nos. 0 to 63 is arranged in a double word unit having 32 bits (4 bytes). An arithmetic operation is executed from Packet Nos. 0 to 63 so as to calculate the check symbol E₀ in each double word unit, and a result of the calculation is stored in Packet No. 64. Further, the check symbol E₁ is calculated in each double word unit, and a result of the calculation is stored in Packet No. 65.

When data is recorded in a recording medium through the format shown by Table 1, the check symbol E₀ is calculated by each double word unit. A general expression of the calculation is shown by the following Expression (5). In the following Expression (5), D₁, D₂, D₃, . . . , Dₖ denote user symbols of Packet Nos. 0 to 63 in each double word unit, and each user symbol is composed of, for example, 32 bits. Note that in the case of Table 1, the number k of the above symbols is 63. E₀, E₁, E₂, . . . , Eₙ₋ₖ₋₁, denote the check symbols, and the number of the check symbols is n−k. It should be noted that Table 1 shows a case in which number of the check symbols is 2.

$${D}_{1} + {D}_{2} + {D}_{3} + ⋯ + {D}_{k - 1} + {D}_{k} = {E}_{0 } \\ {α}^{k} {D}_{1} + {α}^{k - 1} {D}_{2} + {α}^{k - 2} {D}_{3} + ⋯ + {α}^{2} {D}_{k - 1} + α {D}_{k} = {E}_{1 } \\ {α}^{{( k )}^{2}} {D}_{1} + {α}^{{( k - 1 )}^{2}} {D}_{2} + {α}^{{( k - 2 )}^{2}} {D}_{3} + ⋯ + {α}^{4} {D}_{k - 1} + {α}^{2} {D}_{k} = {E}_{2} \\ ⋮ ⋮ \\ {α}^{{( k )}^{n - k - 1}} {D}_{1} + {α}^{{( k - 1 )}^{n - k - 1}} {D}_{2} + ⋯ + {α}^{n - k} {D}_{k - 1} + {α}^{n - k - 1} {D}_{k} = {E}_{n - k - 1} \qquad ( 5 )$$

Next, when the data is decoded from the recording medium, the arithmetic operation of the following Expression (6) is executed. As shown below, the magnitude of a data error is determined from symbols S₀, S₁, S₂, . . . , Sₙ₋ₖ₋₁ which are determined by this arithmetic operation.

$${D}_{1} + {D}_{2} + {D}_{3} + ⋯ + {D}_{k - 1} + {D}_{k} + {E}_{0} = {S}_{0} \\ {α}^{k} {D}_{1} + {α}^{k - 1} {D}_{2} + {α}^{k - 2} {D}_{3} + ⋯ + {α}^{2} {D}_{k - 1} + α {D}_{k} + {E}_{1} = {S}_{1} \\ {α}^{{( k )}^{2}} {D}_{1} + {α}^{{( k - 1 )}^{2}} {D}_{2} + {α}^{{( k - 2 )}^{2}} {D}_{3} + ⋯ + {α}^{4} {D}_{k - 1} + {α}^{2} {D}_{k} + {E}_{2} = {S}_{3} \\ ⋮ ⋮ \\ {α}^{{( k )}^{n - k - 1}} {D}_{1} + {α}^{{( k - 1 )}^{n - k - 1}} {D}_{2} + ⋯ + {α}^{n - k} {D}_{k - 1} + {α}^{n - k - 1} {D}_{k} + {E}_{n - k - 1} = {S}_{n - k - 1} \qquad ( 6 )$$

In encoding and decoding, the arithmetic operations of Expressions (5) and (6) can be executed with an a( multiplier having a symbol number up to −1. Note that i shows numbers 0, 1, 2, 3, . . . , k. It should be noted that the symbol “+” in the above Expression (1) or later expressions shows an exclusive OR (ExOR).

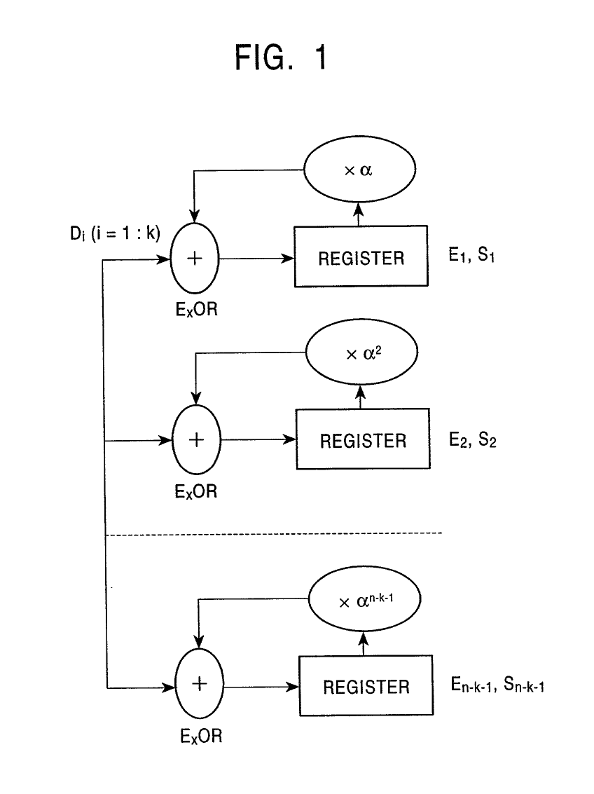

First, while the check symbols E₀ and S₀ in Expressions (5) and (6) can simply be calculated by exclusive OR, power calculation is necessary to calculate E₁, S₁ and later. FIG. 1 shows an example of an arithmetic operation circuit for executing this calculation. As shown in FIG. 1, D₁, D₂, D₃, . . . , Dₖ are stored in a register, and each of them is subjected to power calculation of α, α², . . . , α^{n-k-1} to thereby calculate E₁, E₂, . . . , Eₙ₋ₖ₋₁ and S₁, S₂, . . . , Sₙ₋ₖ₋₁.

The calculation method and the arithmetic operation unit of the present invention for increasing the speed of the power calculation will now be described.

The primitive polynomial GF(2) of a Galois field is represented by the following Expression (7).

G₍ₓ₎=gₘx^{m}+gₘ₋₁x^{m-2}+gₘ₋₂x^{m-2}+. . . +gₚ₊₁x^{p+1}+gₚx^{p}+. . . +g₀ . . . (7)

The primitive polynomial GF(2) of the Galois field will be described using the following Expression (8) as an example so that the principle of the arithmetic operation unit can be explained in simplified terms.

G₍ₓ₎=X⁸+X⁴+X³+X²+1 . . . (8)

In Expressions (4) and (5) , when symbols corresponding to the user symbols D₁, D₂, D₃, . . . , Dₖ are represented by u₇, u₆, u₅, u₄, u₃, u₂, u₁, u₀, each composed of 8 bits, U (u₇, u₆, u₅, u₄, u₃, u₂, u₁, u₀) is represented by the following Expression (9).

U=α⁷u₇+α⁶u₆+α⁵u₅+α⁴u₄+α³u₃+α²u₂+α¹u₁+u₀ . . . (9)

Further, α·U is represented by the following Expression (10).

α·U=α⁸u₇α⁷u₆+α⁶u₅+α⁵u₄+α⁴u₃+α³u₂+α²u₁+α₀ . . . (10)

The α·U represented by Expression (10) is equal to what is obtained by shifting u₇, u₆, u₅, u₄, u₃, u₂, u₁ and u₀ by 1 bit as to the elements of Expression (9) so as to obtain the following Expression (11), and by adding (ExORing) Expression (12) obtained from the primitive polynomial of Expression (8) to Expression (11).

α⁷u₆+α⁶u₇+α⁵u₄+α⁴u₃+α²u₁+α¹u₀ . . . (11)

α⁸(=α⁴+α³+α²+1)·u₇ . . . (12)

Accordingly, the arithmetic operation from U to α·U can be executed at a high speed by preparing two types of look-up tables (reference sections, Table 2) for a case in which the least significant bit u₇ of U is “1” and a case in which it is “0”, together with a shift operating section.

TABLE 2

| u7 | Value of look-up table |
|---|---|
| 0 | 0 |
| 1 | α⁴ + α³ + α² + α¹ |

Next, α²·U is represented as shown by the following Expression (13).

α²·U=α⁹u₇+α⁸u₆+α⁷u₅+α⁶u₄+α⁵u₃+α⁴u₂+α³u₁+α²u₀ . . . (13)

This is equal to what is obtained by shifting the elements of U of Expression (9) by 2 bits and by adding (ExORing) the following Expression (14) to the resultant expression.

α⁹(=α·(α⁴+α³+α²+1))·u₇+α⁸(=α⁴+α³+α²+1)·u₆ . . . (14)

That is, it is sufficient to prepare 4 (=2²) types of look-up tables (Table 3) according to the least significant 2-bit values of the elements of U, to shift U by 2 bits, and to subject the resultant expression to ExORing.

TABLE 3

| | |
|---|---|
| u6,u7 | Value of look-up table |
| 00 | 0 |
| 01 | α⁴ + α³ + α² + α¹ |
| 10 | α(α⁴ + α³ + α² + α¹) |
| 11 | α(α⁴ + α³ + α² + α¹) |
| | +α⁴ + α³ + α² + α¹ |

Since the shift operation is generally included in CPO and the look-up tables can be realized by a memory of a small capacity, the shift operation is a generally applicable and high speed arithmetic operation method.

The aforementioned procedure can be employed also in α³·U, α⁴·U and so on in the same manner. That is, a high speed calculation of αⁱ can be executed by providing: 1) an i-bit shift section; and 2) 2ⁱ types of look-up tables (referring sections)

Next, an error correction executed by the symbols S₀, S₁, S₂, . . . , Sₙ₋ₖ₋₁ will be described.

When the data reproduced from the recording medium has no error, all of the S₀, S₁, S₂, . . . , Sₙ₋ₖ₋₁ in Expression (6) are 0. Further, when an error arises in the user symbols, the magnitude of the error can be calculated by the following arithmetic operation if lost data, in which a portion where an error arises is previously known, is to be corrected. For example, when it is assumed that errors in the user symbols arise at i-th and j-th positions from a rear side and that the magnitudes of the errors are represented by eᵢ and eⱼ, the relationship between the magnitudes of the errors and the symbols S₀ and S₁ is represented by the following Expression (15).

eᵢ+eⱼ=S₀

αⁱeᵢ+αeⱼ=S₁ . . . (15)

When eᵢ and eⱼ are determined from Expression (15), they are represented by Expression (16), which can be solved as simultaneous equations with two unknowns.

$${e}_{i} = \frac{{α}^{j} \cdot {S}_{0} \cdot {S}_{1}}{{α}^{i} + {α}^{j}} \\ {e}_{j} = \frac{( {α}^{j} \cdot {S}_{0} \cdot {S}_{1} ) \cdot {α}^{- i}}{1 + {α}^{j - 1}} \qquad ( 16 )$$

Next, since the occurrence of an error eⱼ in the check symbol E₀ results in the following expression 17, the magnitude of the error eᵢ can be solved by a linear equation.

eᵢ+eⱼ=S₀

αⁱeᵢ=S₁ . .. (17)

Similarly, when errors eᵢ, eⱼ, and eₖ arise at three position of the user symbols, the magnitude of the error eᵢ (Expression (19)) can be determined by solving simultaneous equations with three unknowns shown in Expression (18).

eᵢ+eⱼ+eₖ=S₀

αⁱeᵢ+α^{j}eⱼ=S₁

α²ⁱeᵢ+α^{2j}eⱼ=S₂ . . . (18)

$${e}_{i} = \frac{{α}^{j} \cdot {α}^{k} \cdot {S}_{0} \cdot {α}^{j} \cdot {S}_{1} \cdot {α}^{k} \cdot {S}_{1} + {S}_{2}}{( - {α}^{i} + {α}^{j} ) ( - {α}^{i} + {α}^{k} )} \\ {e}_{j} = \frac{( {α}^{j} {α}^{k} {S}_{0} {α}^{j} {S}_{1} {α}^{k} {S}_{1} + {S}_{2} ) {α}^{- j - k}}{( 1 - {α}^{i - j} ) ( 1 - {a}^{i - k} )} \qquad ( 19 )$$

eⱼ and eₖ can be calculated in the same way.

In the above arithmetic operation, as the degree of the primitive polynomial increases, an amount of inverse elements to be calculated is increased. Thus, it is advantageous to deform the primitive polynomial so that it is within a predetermined value and to refer to inverse elements by a look-up table system from a view point of speed. As to the inverse elements, it is sufficient to provide the following two types of tables (referring section):

a) α¹, α², . . . , α^{k} (k: number of user symbols), and

b) 1+α¹, 1+α², . . . , 1+α^{k} (k: number of user symbols).

As described above, according to the present invention, it is possible to execute an arithmetic operation for error correction using the primitive polynomial of a Galois field.

What is claimed is:

1. An arithmetic operation unit for multiplying _60 ⁱ when an element of G (X)=0 of a primitive polynomial G (X) on a Galois field) is represented by α, comprising:
a shift operating section for shifting elements by i bits before multiplication; and
a referring section for referring to a look-up table of 2ⁱ pieces of elements when the multiplier of α is represented by i,
wherein the element of G (X)=0 of the primitive polynomial G(X) on the Galois field is represented by the following expression:
G₍ₓ₎=gₘx^{m}+gₘ₋₁x^{m-2}+gₘ₋₂x^{m-2}+. . . +gₚ₊₁x^{p+1}+gₚx^{p}+. . . +g₀.

2. An arithmetic operation unit for calculating U αⁱ based on an element U on a Galois field represented by the following expression:
U=αⁿuₙ+αⁿ⁻¹uₙ₋₁+. . . +α²u₂+α¹u₁+u₀,
when an element of G₍ₓ₎=0 of a primitive polynomial G₍ₓ₎ on the Galois field is represented by the following expression:
G₍ₓ₎=gₘx^{m}+gₘ₋₁x^{m-2}+gₘ₋₂x^{m-2}+. . . +gₚ₊₁x^{p+1}+gₚx^{p}+. . . +g₀,
is represented by α, wherein a shift operating section for shifting the element U by i bits is ExOred with a referring section for referring to a look-up table having 2ⁱ pieces of elements according to the least significant i bits of U.

3. An arithmetic operation unit according to claim 2, wherein when data is represented by D₁, D₂, . . . , Dₖ, error check symbols E₀, E₁, E₂, . . . , Eₙ₋ₖ₋₁ are calculated by the following expression:
$${D}_{1} + {D}_{2} + {D}_{3} + ⋯ + {D}_{k - 1} + {D}_{k} = {E}_{0 }$$
$${α}^{k} {D}_{1} + {α}^{k - 1} {D}_{2} + {α}^{k - 2} {D}_{3} + ⋯ + {α}^{2} {D}_{k - 1} + α {D}_{k} = {E}_{1}$$
$${α}^{{( k )}^{2}} {D}_{1} + {α}^{{( k - 1 )}^{2}} {D}_{2} + {α}^{{( k - 2 )}^{2}} {D}_{3} + ⋯ + {α}^{4} {D}_{k - 1} + {α}^{2} {D}_{k} = {E}_{2}$$
$$⋮ ⋮$$
$${α}^{{( k )}^{n - k - 1}} {D}_{1} + {α}^{{( k - 1 )}^{n - k - 1}} {D}_{2} + ⋯ + {α}^{n - k} {D}_{k - 1} + {α}^{n - k - 1} {D}_{k} = {E}_{n - k - 1}$$

4. An arithmetic operation unit according to claim 3, wherein when data is decoded, symbols S₀, S₁, S₂, . . . , Sₙ₋ₖ₋₁ are obtained by calculating the following expression:

5. An arithmetic operation unit according to claim 4, wherein when the magnitude of an error is determined using the symbols S₀, S₁, S₂, . . . , Sₙ₋ₖ₋₁, the magnitude of the error is determined by providing an inverse element reference table of the form:
a) α¹, α², . . . α^{k}, and
b) 1+α¹, 1+α², . . . 1+α^{k}, and by referring to the table.
